(19) United States
(12) Patent Application Publication
(10) Pub. No.: US 2018/0199759 A1
(43) Pub. Date: Jul. 19, 2018

(54) TOBACCO GRINDER

(71) Applicant: Changzhou Patent Electronic Technology Co.,ltd, Changzhou (CN)

(72) Inventor: WEI-HUA QIU, ChangZhou (CN)

(21) Appl. No.: 15/871,129

(22) Filed: Jan. 15, 2018

(30) Foreign Application Priority Data
Jan. 18, 2017 (CN) 201720061406.X

(51) Int. Cl. A47J 42/20

(52) U.S. Cl. CPC A47J 42/20

(57) ABSTRACT

A tobacco grinder allowing direct transfer of ground tobacco to a smoking implement to eliminate waste includes an upper cover, a middle cover, and a material receiving base. The upper cover is rotatably positioned at one end of the middle cover the material receiving base is detachably connected to the end of the middle cover. A space between the upper cover and the middle cover defines a grinding cavity. A filter hole is defined on the middle cover, and a discharge hole is defined on the material receiving base, forming an escape path for tobacco which has been ground into particles. A sealing member is detachably coupled to the discharge hole, thus the discharge hole can be closed or opened. The ground tobacco can be directly transferred as required into the electronic cigarette.

### FIELD

The present disclosure relates to an apparatus for grinding material, such as tobacco, and more particularly to a tobacco grinder from which ground tobacco therein can be directly entered into an electronic cigarette to avoid pollution and waste.

### BACKGROUND

Tobacco grinder is a tool for grinding dry tobacco leaves into small pieces. Generally, after the tobacco leaves are ground by the tobacco grinder, it is necessary to use hand or other tools to take the ground tobacco leaves out and fill them into a smoke pan of an electronic cigarette for use. The above process is tedious. In addition, during taking out the ground tobacco to the electronic cigarette, there may be inevitable pollution and waste of tobacco.

### SUMMARY

A tobacco grinder is disclosed, from which ground tobacco therein can be directly entered into an electronic cigarette to avoid pollution and waste.

The tobacco grinder includes an upper cover, a middle cover, and a material receiving base. The upper cover is rotatably positioned at an end of the middle cover, the material receiving base is detachably connected with another end of the middle cover. A space between the upper cover and the middle cover defines a grinding cavity, an inner cavity of the material receiving base defines a receiving cavity, and at least one filter hole is defined on the middle cover. The filter hole communicates with the grinding cavity and the receiving cavity. A discharge hole is defined on the material receiving base and communicates with the receiving cavity, and a sealing member is detachably coupled to the discharge hole, thus the sealing member is capable of closing or opening the discharge hole.

A hollow connecting column corresponding to the discharge hole protrudes from the material receiving base towards the middle cover. The connecting column defines an opening, and an abutting portion outwardly extends from an end portion of the sealing member along the radial direction of the sealing member. When the sealing member is arranged in the connecting column, the abutting portion abuts against the connecting column.

The tobacco grinder further includes a lower cover detachably connected with an end of the material receiving base away from the middle cover.

A first coupling portion extends from the material receiving base towards the middle cover 20 and a third protruding portion is positioned on the first coupling portion. A second connecting portion extends from the lower cover towards the material receiving base, a fourth protruding portion is positioned on the second coupling portion corresponding to the third protruding portion, and the material receiving base is connected with the lower cover via the cooperation of the third protruding portion and the fourth protruding portion.

A number of first grinding gears are positioned on the upper cover, the first grinding gears extend towards the middle cover and are arranged uniformly along a circumference of the upper cover. A number of second grinding gears are positioned on the middle cover, the second grinding gears extend towards the upper cover and are staggered in relation to the first grinding gears.

At least one blocking portion is positioned on the middle cover and extends towards the upper cover, the blocking portion is configured to cooperate with the first grinding gears.

The profiles of the first grinding gears and the second grinding gears are substantially in shape of triangular pyramid.

A spindle is positioned in a center of the upper cover and the middle cover, an axle or spindle hole is defined at a centers of the upper cover and the middle cover. The spindle is coupled with the axle hole, and the upper cover and the middle cover can rotate relative to each other around the spindle.

A first magnetic member is positioned on the spindle and a second magnetic member is positioned in the axle hole. When the spindle is coupled to the axle hole, the first magnetic member is magnetically coupled to the second magnetic member.

A first protruding portion is positioned on the middle cover. A second protruding portion is positioned on the material receiving base and cooperates with the first protruding portion. The material receiving base is connected with the middle cover via the cooperation of the first protruding portion and the second protruding portion.

The ground tobacco can be poured out from the discharge hole of the tobacco grinder directly into the electronic cigarette, to complete the filling of tobacco to the electronic cigarette. Compared with structure of a traditional tobacco grinder, hands or other instruments to extract the ground tobacco and place in the electronic cigarette are not required. In addition, the tobacco grinder has simple structure, and is convenient to operate.

### BRIEF DESCRIPTION OF THE DRAWINGS

The utility model is described with reference to the accompanying drawings and embodiments.

FIG. 1 is a schematic view of an embodiment of a tobacco grinder.

FIG. 2 is a perspective, exploded view of the tobacco grinder of FIG. 1.

FIG. 3 is an exploded view of the tobacco grinder of FIG. 1 viewed from another aspect.

FIG. 4 is a cross-sectional view of the tobacco grinder of FIG. 1.

FIG. 5 is a schematic view of the tobacco grinder of FIG. 1 without lower cover and arranged on a smoke pan.

### DETAILED DESCRIPTION

Detailed description of specific embodiments of the present application will be given with reference to the accompanying drawings. A number of specific details are set forth in the following description so as to fully explain the present application. However, the present application can be implemented in many other ways different from those described herein, and those skilled in the art can make similar improvements without violating the contents of the present application. Therefore, the present description is not to be considered as limiting the scope of the embodiments described herein.

Several definitions that apply throughout this disclosure will now be presented.

The term “coupled” is defined as coupled, whether directly or indirectly through intervening components, and is not necessarily limited to physical connections. The connection may be such that the objects are permanently coupled or releasably coupled. The term “substantially” is defined to be essentially conforming to the particular dimension, shape, or other feature that the term modifies, such that the component need not have that exact feature. The term “comprising,” when utilized, means “including, but not necessarily limited to”; it specifically indicates open-ended inclusion or membership in the so-described combination, group, series, and the like.

It should be noted that, when an element is considered to be “fixed to” another element, it can be either directly fixed on another element or indirectly fixed on another element with a centered element. When an element is considered to be “coupled with” another element, it can be either directly coupled with another element or indirectly coupled with another element.

Unless otherwise defined, all technical and scientific terms used herein have the same meaning as commonly understood by one skilled in the art. The terms used in a specification of the present application herein are only for describing specific embodiments, and are not intended to limit the present application. The terms “and/or” used herein includes any and all combinations of one or more of associated listed items.

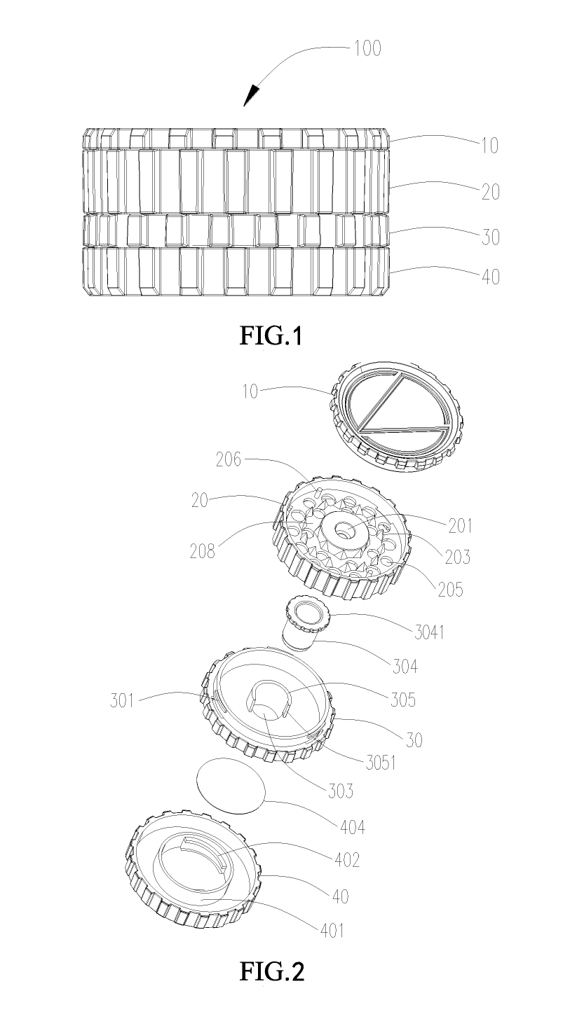

Referring to the FIG. 1, a tobacco grinder 100 is disclosed. The tobacco grinder 100 includes an upper cover 10, a middle cover 20, a material receiving base 30, and a lower cover 40. The upper cover 10 is positioned on an end of the middle cover 20. The material receiving base 30 and the lower cover 40 are positioned at other end of the middle cover 20, in that order. The material receiving base 30 is located between the middle cover 20 and the lower cover 40. The upper cover 10 is rotatably connected with the middle cover 20. The middle cover 20, the material receiving base 30, and the lower cover 40 are detachably connected to each other. In the illustrated embodiment, an end of the material receiving base 30 is detachably connected with the middle cover 20, and other end of the material receiving base 30 is detachably connected with the lower cover 40. In order to rotate and disassemble the device easily, each of the upper cover 10, the middle cover 20, the material receiving base 30, and the lower cover 40 includes anti-skid stripes or ridges at a peripheral wall.

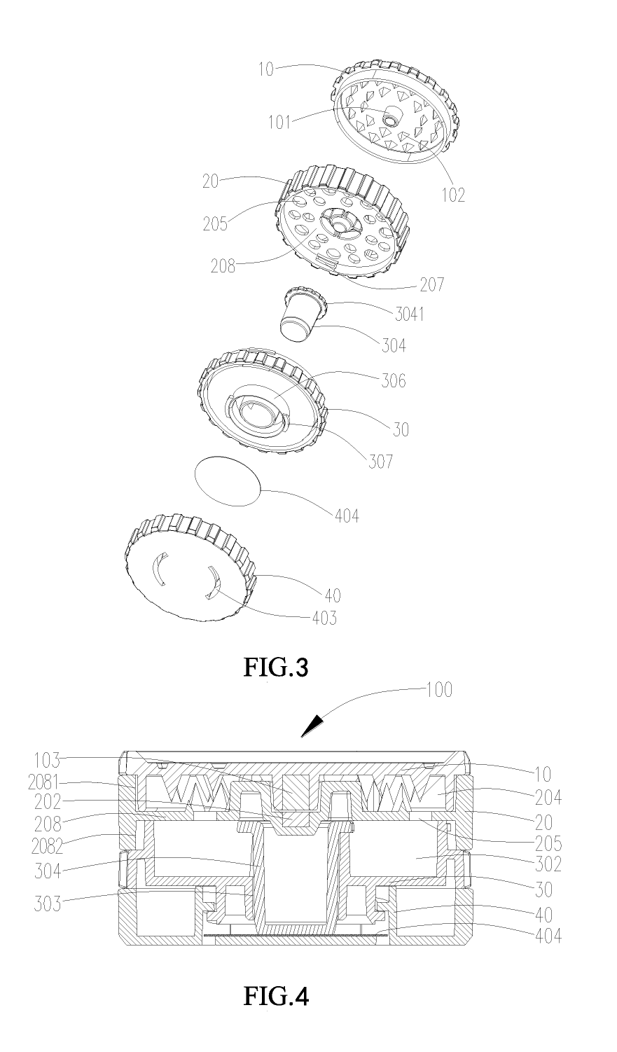

Referring to the FIG. 2 and FIG. 3, the upper cover 10 is substantially a hollow cylindrical structure. An end of the upper cover 10 adjacent to the middle cover 20 defines an opening. A center portion of an upper wall of the top cover 10 extends along the axial direction of the top cover 10 toward the middle cover 20 to form a spindle 101. A number of first grinding gears 102 are positioned on the upper wall of the upper cover 10. The first grinding gears 102 extend toward the middle cover 20 and are uniformly arranged along a circumference of the upper cover 10. In the illustrated embodiment, the first grinding gears 102 are positioned as two concentric circles around the central axis of the upper cover 10 or the spindle 101, for grinding tobacco leaves adequately. In an alternative embodiment, the first grinding gears 102 can arranged as one or as more than two circles.

Referring to the FIG. 2 to FIG. 4, the middle cover 20 is substantially a hollow cylindrical structure with openings at opposite ends. A blocking board 208 is positioned in the middle cover 20. The blocking board 208 separates an inner cavity of the middle cover 20 into an upper cavity 2081 facing the upper cover 10 and a lower cavity 2082 away from the upper cover 10. The blocking board 208 defines an axle hole 201 corresponding to the spindle 101. In the illustrated embodiment, the axle hole 201 corresponding to the spindle 101 is defined at the central portion of a sidewall of the blocking board 208 adjacent to the upper cover 10. That is, the axle hole 201 is positioned at a bottom wall of the upper cavity 2081. When the axle hole 201 receives the spindle 101, the middle cover 20 and the upper cover 10 are connected together, and are rotatable around the spindle 101. In addition, the axle hole 201 can be configured to limit rotation of the spindle 101, to prevent the middle cover 20 and the upper cover 10 from being separated during rotation.

In an alternative embodiment, the spindle 101 can be positioned at a center portion of a sidewall of the blocking board 208 facing the upper cover 10. The axle hole 201 can be positioned at a center portion of an upper wall of the upper cover 10, and the upper cover 10 and the middle cover 20 also can be rotatably connected together around the spindle 101.

In the illustrated embodiment, the axle hole 201 is a blind hole. In an alternative embodiment, the axle hole 201 can be a through hole.

In the illustrated embodiment, a first magnetic member 103 is positioned at the spindle 101. A second magnetic member 202 is positioned in the axle hole 201. The magnetic attraction between the first magnetic member 103 and the second magnetic member 202 can further prevent the middle cover 20 and the upper cover 10 from separating during rotation. In an alternative embodiment, the first magnetic member 103 and the second magnetic member 202 are magnets.

Referring to the FIG. 2 and FIG. 4, a number of second grinding gears 203 are positioned on a sidewall of the blocking board 208 facing the upper cover 10. The second grinding gears 203 extend towards the upper cover 10 and are staggered with the first grinding gears 102. A cavity (i.e, the space between the upper cavity 2081 and the inner cavity of the upper cover 10) between the middle cover 20 and the upper cover 10 are defined as a grinding cavity 204 for receiving the tobacco leaves. The blocking board 208 of the middle cover 20 defines a number of filter holes 205. The filter holes 205 are in communication with the grinding cavity 204 and the lower cavity 2082, thus the grinding cavity 204 is in communication with the lower cavity 2082. When the tobacco grinder 100 is in use, the tobacco leaves are put in the grinding cavity 204. When the middle cover 20 and the upper cover 10 rotate relative to each other, tobacco leaves are ground into small pieces by the first grinding gears 102 and the second grinding gears 103. Ground tobacco particles of a certain size leak from the filter hole 205 to the material receiving base 30.

In the illustrated embodiment, the first grinding gears 102 and the second grinding gears 203 are substantially in shape of triangular pyramid, to grind the tobacco leaf more thoroughly.

Referring to the FIG. 2, in order to prevent some of tobacco leaves from adhering to the outermost first grinding gears 102 during the grinding process, two blocking portions 206 are positioned on the sidewall of the blocking board 208 facing the upper cover 10, and extend towards the upper cover 10. The two blocking portion 206 are configured to cooperate with the outermost ring of the first grinding gears 102. In an alternative embodiment, a number of the blocking portions 206 can be one or more than two. During the grinding process, the blocking portions 206 scrape off the tobacco leaves adhered on the outermost first grinding gears 102, thus the scraped off tobacco leaves can be ground and/or leaked to the material receiving base 30. In the illustrated embodiment, the blocking portion 206 is substantially cylindrical.

Referring to the FIG. 2 and FIG. 3, the material receiving base 30 is substantially a hollow cylindrical structure. An opening is defined at an end portion of the material receiving base 30 adjacent to the middle cover 20. For connecting the receiving base 30 with the middle cover 20 conveniently, at least one first protruding portion 207 is positioned on an inner sidewall of the lower cavity 2082. At least one second protruding portion 301 is positioned on an outer sidewall of the material receiving base 30. The first protruding portion 207 and the second protruding portion 301 are substantially spiral protrusions. The receiving base 30 and the middle cover 20 are connected together via the cooperation of the first protruding portion 207 and the second protruding portion 301. In the illustrated embodiment, a number of the first protruding portions 207 is two. In the illustrated embodiment, a number of the second protruding portions 301 is four.

Referring to the FIG. 4, the material receiving base 30 defines a material receiving cavity 302. The receiving base 30 is at least partially received in the lower cavity 2082 when the receiving base 30 is connected to the middle cover 20. Therefore, the material receiving cavity 302 communicates with the filter hole 205, thus the tobacco particles in the grinding cavity 204 leak into the material receiving cavity 302 via the filter holes 205. A discharge hole 303 communicating with the material receiving cavity 302 is defined at the center portion of the bottom wall of the material receiving base 30 (i.e, the bottom wall of the material receiving cavity 302). A sealing member 304 is detachably mounted to the discharge hole 303. When the sealing member 304 is mounted to the discharge hole 303, the discharge hole 303 is sealed, and the tobacco particles cannot leak from the discharge hole 303. When the sealing member 304 is detached, the discharge hole 303 is opened and the tobacco chippings can freely escape via the discharge hole 303.

Referring to the FIG. 2, in the illustrated embodiment, a hollow connecting column 305 corresponding to the discharge hole 303 protrudes from the center portion of the material receiving base 30 towards the middle cover 20. A groove 3051 is defined on the sidewall of the connecting column 305, for facilitating the escape of the ground tobacco particles. The sealing member 304 is substantially a hollow cylindrical structure. An opening is defined at an end portion of the sealing member 304. An abutting portion 3041 outwardly extends from the end portion defining the opening of the sealing member 304 along the radial direction of the sealing member 304. When the sealing member 304 is mounted in the connecting column 305, the sealing member 304 seals the discharging hole 303, and the abutting portion 3041 resists an end of the connecting column 305 adjacent to the middle cover 20. This prevents the sealing member 304 from separating from the discharging hole 303 and prevents the discharge hole 303 from opening. In the illustrated embodiment, diameter of the opening of the sealing member 304 is substantially equal to a width of a finger of a user. It is convenient for the user inserting a finger into the opening of the sealing member 304 to detach and install the sealing member 304.

Referring to the FIG. 3, a first coupling portion 306 extends from the center portion of an end surface of the material receiving base 30 away from the middle cover 20 along a direction away from the middle cover 20. At least one of a third protruding portion 307 is positioned on an outer sidewall of the first coupling portion 306. The third protruding portion 307 is a substantially a spiral protrusion. In the illustrated embodiment, a number of the third protruding portions 307 is two.

Referring to the FIG. 2, the lower cover 40 is substantially a hollow cylindrical structure. The lower cover 40 defines an opening at an end portion thereof adjacent to the material receiving base 30. A second coupling portion 401 extends from a center portion a bottom wall of the lower cover 40 towards the material receiving base 30. At least one of a fourth protruding portion 402 is positioned on an inner wall of the second coupling portion 401. The fourth protruding portion 402 is a helical protruding portion. The lower cover 40 and the material receiving base 30 are screwed together and connected by the cooperation of the fourth protruding portion 402 and the third protruding portion 307. In the illustrated embodiment, a number of the fourth protruding portions 402 is two.

Referring to the FIG. 3, in the illustrated embodiment, during manufacturing of the lower cover 40, in order for fast die sinking, an opening 403 can be positioned on a bottom portion of the lower cover 40. However, if the sealing member 304 does not seal the discharge hole 303 completely, a slight amount of tobacco particles will leak out from the discharge hole 303 to the lower cover 40, and may further leak out from the opening 403, which results in waste. Referring to the FIG. 2 and FIG. 4, in the illustrated embodiment, a blocking member 404 is positioned on the lower cover 40 corresponding to the opening 403. The opening 403 is blocked by the blocking member 404 and prevents tobacco particles from leaking out. In the illustrated embodiment, the blocking member 404 is a thin plastic sheet.

In order to be able to observe the condition of the tobacco leaves being ground inside the tobacco grinder 100, the upper cover 10, the middle cover 20, the material receiving base 30, and the lower cover 40 are made of transparent or translucent materials. In the illustrated embodiment, the upper cover 10, the middle cover 20, the material receiving base 30, and the lower cover 40 are made of transparent plastic.

In an alternative embodiment, the middle cover 20 and the material receiving base 30 can be threaded. The lower cover 40 and the material receiving base 30 can also be threaded.

In an alternative embodiment, the sealing member 404 can be integrally formed with the lower cover 40.

In an alternative embodiment, the lower cover 40 can be omitted.

A process of using the tobacco grinder 100 of the present disclosure is described.

Referring to the FIG. 4, the tobacco leaves are put in the grinding cavity 204. The upper cover 10 and the middle cover 20 are rotated against each other, and the tobacco leaves become ground particles under the grinding of the first grinding gears 102 and the second grinding gears 203. The tobacco particles of a certain size leak out through the filter hole 205 into the material receiving cavity 302.

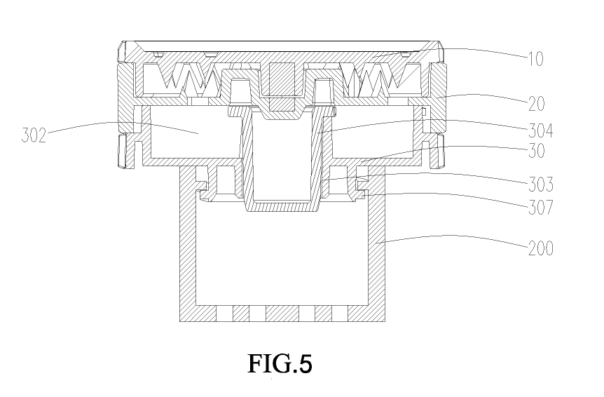

Referring to the FIG. 5, when a user needs to add the ground tobacco particles to the electronic cigarette, firstly, the lower cover 40 is removed by the user. Secondly, the material receiving base 30 is screwed on a smoke pan 200 of the electronic cigarette through the third protruding portion 307, to align the discharge hole 303 with the smoke pan 200. Thirdly, the upper cover 10, the middle cover 20, and the sealing member 304 are removed sequentially. Thus, the discharge hole 303 is opened, and the material receiving cavity 302 is in communication with the smoke pan 200 through the discharge hole 303. Therefore, the tobacco particles can pass through the discharge hole 303 and enter into the smoke pan 200, to complete the filling of the electronic cigarette.

In an alternative embodiment, the tobacco particles can also be transferred to a storage device through the discharge hole 303. The tobacco stored in the storage device can be added into the smoke pan 200 when needed by a user.

In the present disclosure, ground tobacco particles can be loaded into the electronic cigarette. Compared with the conventional structure, the tobacco grinder 100 of the present disclosure can avoid a pollution or a waste of the tobacco. In addition, the tobacco grinder 100 of the present disclosure has a simple structure and is easy to operate.

Various changes and modifications can be made without departing from the scope of the present disclosure. The technical scope of the present disclosure is not limited to the contents of the specification, and the technical scope of the present disclosure must be determined according to the scope of the claims.

What is claimed is:

1. A tobacco grinder comprising an upper cover, a middle cover and a material receiving base, the upper cover rotatably positioned at an end of the middle cover, the material receiving base detachably connected with another end of the middle cover, a space between the upper cover and the middle cover defining a grinding cavity, an inner cavity of the material receiving base defining a receiving cavity, at least one filter hole defined on the middle cover, and communicating the grinding cavity with the receiving cavity, a discharge hole defined on the material receiving base and communicated with the receiving cavity, a sealing member detachably coupled to the discharge hole, thus the sealing member capable of closing or opening the discharge hole.

2. The tobacco grinder as claimed in claim 1, wherein a hollow connecting column corresponding to the discharge hole protrudes from the material receiving base towards the middle cover, the connecting column defines an opening, an abutting portion outwardly extends from an end portion of the sealing member along the radial direction of the sealing member, when the sealing member is arranged in the connecting column, the abutting portion abuts against the connecting column.

3. The tobacco grinder as claimed in claim 1, wherein the tobacco grinder further comprises a lower cover detachably connected with an end of the material receiving base away from the middle cover.

4. The tobacco grinder as claimed in claim 3, wherein a first coupling portion extends from the material receiving base towards the middle cover 20 a third protruding portion is positioned on the first coupling portion, a second connecting portion extends from the lower cover towards the material receiving base, a fourth protruding portion is positioned on the second coupling portion corresponding to the third protruding portion, the material receiving base is connected with the lower cover via the cooperation of the third protruding portion and the fourth protruding portion.

5. The tobacco grinder as claimed in claim 1, wherein a plurality of first grinding gears are positioned on the upper cover, the plurality of the first grinding gears extend towards the middle cover and are arranged uniformly along a circumference of the upper cover, a plurality of second grinding gears are positioned on the middle cover, the plurality of the second grinding gears extend towards the upper cover and staggered with the first grinding gear.

6. The tobacco grinder as claimed in claim 5, wherein at least one blocking portion is positioned on the middle cover and extends towards the upper cover, the blocking portion is configured to cooperate with the first grinding gear.

7. The tobacco grinder as claimed in claim 5, wherein the first grinding gear and the second grinding gear are substantially in shape of triangular pyramid.

8. The tobacco grinder as claimed in claim 1, wherein a spindle is positioned in a center of one of the upper cover and the middle cover, an axle hole is defined at a center of another one of the upper cover and the middle cover, when the spindle is coupled with the axle hole, the upper cover and the middle cover can rotate relative to each other around the spindle.

9. The tobacco grinder as claimed in claim 8, wherein a first magnetic member is positioned on the spindle, a second magnetic member is positioned in the axle hole, when the spindle is coupled to the axle hole, the first magnetic member is magnetically coupled to the second magnetic member.

10. The tobacco grinder as claimed in claim 1, wherein a first protruding portion is positioned on the middle cover, a second protruding portion is positioned on the material receiving base and corresponds to the first protruding portion, the material receiving base is rotatably connected with the middle cover via the cooperation of the first protruding portion and the second protruding portion.
